(19) United States
(12) Patent Application Publication
(10) Pub. No.: US 2022/0086275 A1
(43) Pub. Date: Mar. 17, 2022

(54) VOICE COMMUNICATION SYSTEM WITH ECHO CANCELLATION AND OPERATION METHOD THEREOF

(71) Applicant: Ching-Lun CHO, New Taipei City (TW)

(72) Inventor: Ching-Lun CHO, New Taipei City (TW)

(21) Appl. No.: 17/465,377

(22) Filed: Sep. 2, 2021

(30) Foreign Application Priority Data
Sep. 11, 2020 (TW) 109131382

(51) Int. Cl. H04M 3/00; G10L 21/0232

(52) U.S. Cl. CPC H04M 3/002; G10L 2021/02082; G10L 21/0232

(57) ABSTRACT

An operation method of voice communication system with echo-cancellation, comprising following steps of: capturing audio-signal by a first sound capturing portion of a first transceiver device to output a first residual-echo signal to an audio-signal-processing portion of the first transceiver device for echo cancellation; outputting a first echo-cancelled signal by the audio-signal-processing portion to a first communication portion and to a second communication portion of a second transceiver device through a connection and to a second sound generating portion for generating audio-signal; capturing audio-signal by a second sound capturing portion to output a second residual-echo signal to the second communication portion and to the first communication portion of the first transceiver device through the connection and to the audio-signal-processing portion for echo cancellation; outputting a second echo-cancelled signal to a first sound generating portion of the first transceiver device for generating audio-signal.

### FIELD OF THE INVENTION

The present invention is related to a communication system and an operation method thereof, especially a communication system with client-server echo cancellation function architecture and an operation method thereof.

### BACKGROUND OF THE INVENTION

Please refer to FIG. 5, which is a schematic view of an echo cancellation communication system of the conventional technology. The echo cancellation communication system 9 of the conventional technology comprises a first transceiver device 90 and a second transceiver device 91. The first transceiver device 90 comprises a first audio signal processing portion 92, a first communication portion 98, a first sound generating portion 93 and a first sound capturing portion 94, wherein the first communication portion 98 is connected to the first sound generating portion 93 and the first audio signal processing portion 92 respectively. The first sound capturing portion 94 is connected to the first audio signal processing portion 92. The second transceiver device 91 comprises a second audio signal processing portion 95, a second communication portion 99, a second sound generating portion 96 and a second sound capturing portion 97, wherein the second communication portion 99 is connected to the second sound generating portion 96 and the second audio signal processing portion 95 respectively. The second sound capturing portion 97 is connected to the second audio signal processing portion 95. The method of echo cancellation communication of conventional technology comprises following steps of: establishing a network connection 901 between the first communication portion 98 of the first transceiver device 90 and the second communication portion 99 of the second transceiver device 91 for transmitting signals, wherein the network connection 901 is a peer-to-peer network connection; transmitting a first echo-cancelled signal 920 (electrical signal) outputted by the first audio signal processing portion 92 to the first communication portion 98; transmitting the first echo-cancelled signal 920 (electrical signal) from the first communication portion 98 of the first transceiver device 90 to the second communication portion 99 of the second transceiver device 91 through the network connection 901, and then transmitting the first echo-cancelled signal 920 (electrical signal) to the second sound generating portion 96 of the second transceiver device 91; generating a second output audio signal 960 (sound) corresponding to the first echo-cancelled signal 920 (electrical signal) by the second sound generating portion 96; that is the second sound generating portion 96 converts the first echo-cancelled signal 920 (electrical signal) into the second output audio signal 960 (sound); hence, the second output audio signal 960 (sound) generated by the second sound generating portion 96 and heard by a second user 962 in an environment 903 where the second transceiver device 91 is placed is the audio signal (sound) that has been echo-cancelled; capturing a second input audio signal 970 (sound) by the second sound capturing portion 97 to output a second residual echo signal 971 (electrical signal) corresponding to the second input audio signal 970 (sound) to the second audio signal processing portion 95; that is, the second sound capturing portion 97 captures the second input audio signal 970 (sound) and converts the second input audio signal 970 (sound) into the second residual echo signal 971 (electrical signal); wherein the second input audio signal 970 (sound) comprises a second external audio signal 963 (sound) and a second feedback audio signal 961 (sound), wherein the second feedback audio signal 961 (sound) is corresponding to the second output audio signal 960 (sound); due to the relative position of the second sound generating portion 96 and the second sound capturing portion 97, it is possible that a part of the second output audio signal 960 (sound) will be directly captured by the second sound capturing portion 97; it is also possible that a part of the second output audio signal 960 (sound) will be captured by the second sound capturing portion 97 after a single reflection or multiple reflections in the environment 903 where the second transceiver device 91 is placed; and the sum of the audio signal (sound) captured by the second sound capturing portion 97 and related to the second output audio signal 960 (sound) is the second feedback audio signal 961 (sound); wherein the second external audio signal 963 (sound) also includes other audio signals (signal) captured by the second sound capturing portion 97 and not related to the second output audio signal 960 (sound); the second external audio signal 963 (sound) may include the sound made by the second user 962 and other external audio signal (sound) in the environment 903 where the second transceiver device 91 is placed; for example, the surrounding noises, the sounds of neighboring people, objects, etc., may be partly captured by the second sound capturing portion 97; these all belong to the second external audio signal 963 (sound); cancelling echo from the second residual echo signal 971 (electrical signal) by the second audio signal processing portion 95 to output a second echo-cancelled signal 950 (electrical signal) to the second communication portion 99; transmitting the second echo-cancelled signal 950 (electrical signal) from the second communication portion 99 of the second transceiver device 91 to the first communication portion 98 of the first transceiver device 90 through the network connection 901; transmitting the second echo-cancelled signal 950 (electrical signal) from the first communication portion 98 to the first sound generating portion 93; generating a first output audio signal 930 (sound) corresponding to the second echo-cancelled signal 950 (electrical signal) by the first sound generating portion 93; that is, the first sound generating portion 93 converts the second echo-cancelled signal 950 (electrical signal) into the first output audio signal 930 (sound); hence, the first output audio signal 930 (sound) generated by the first sound generating portion 93 and heard by a first user 932 in an environment 902 where the first transceiver device 90 is placed is the audio signal (sound) that has been echo-cancelled; capturing a first input audio signal 940 (sound) by the first sound capturing portion 94 to output a first residual echo signal 941 (electrical signal) corresponding to the first input audio signal 940 (sound) to the first audio signal processing portion 92; that is, the first sound capturing portion 94 converts the first input audio signal 940 (sound) into the first residual echo signal 941 (electrical signal); wherein the first input audio signal 940 (sound) comprises a first external audio signal 933 (sound) and a first feedback audio signal 931 (sound), wherein the first feedback audio signal 931 (sound) is corresponding to the first output audio signal 930 (sound); due to the relative position of the first sound generating portion 93 and the first sound capturing portion 94, it is possible that a part of the first output audio signal 930 (sound) will be directly captured by the first sound capturing portion 94; it is also possible that a part of the first output audio signal 930 (sound) will be captured by the first sound capturing portion 94 after a single reflection or multiple reflections in the environment 902 where the first transceiver device 90 is placed; and the sum of the audio signal (sound) captured by the first sound capturing portion 94 and related to the first output audio signal 930 (sound) is the first feedback audio signal 931 (sound); wherein the first external audio signal 933 (sound) also includes other audio signals (signal) captured by the first sound capturing portion 94 and not related to the first output audio signal 930 (sound); the first external audio signal 933 (sound) may include the sound made by the first user 932 and other external audio signal (sound) in the environment 902 where the first transceiver device 90 is placed; for example, the surrounding noises, the sounds of neighboring people, objects, etc., may be partly captured by the first sound capturing portion 94; these all belong to the first external audio signal 933 (sound); cancelling echo from the first residual echo signal 941 (electrical signal) by the first audio signal processing portion 92 to output the first echo-cancelled signal 920 (electrical signal) mentioned above to the first communication portion 98.

In the echo cancellation communication system 9 of the conventional technology, the first transceiver device 90 and the second transceiver device 91 can be two mobile phones of different brands (for example, the first transceiver device 90 is brand A, while the second transceiver device 91 is brand B). The two mobile phones respectively have their own audio signal processing portion (the first audio signal processing portion 92 and the second audio signal processing portion 95). Since brand A and brand B don't know the design of each other's mobile phones (for example, brand A does not know the specifications of the second sound generating portion 96 and the second sound capturing portion 97 used in the second transceiver device 91 of brand B, and their relative positions; while brand B does not know the specifications of the first sound generating portion 93 and the first sound capturing portion 94 used in the first transceiver device 90 of brand A, and their relative positions), brand A and brand B don't know the echo status of each other's mobile phones. Therefore, when the communication signals are transmitted to each other, the signals must have been echo-cancelled (such as the first echo-cancelled signal 920 and the second echo-cancelled signal 950), so that the other can generate the (sound), and thus the quality of the call can be maintained. Hence, for ordinary mobile phones, it is necessary to have their own audio signal processing portion. However, whether the audio signal processing portion uses software, hardware, or software with hardware to cancel echoes, it will consume power when performing echo cancellation, and the audio signal processing portion will also have hardware and software costs.

Accordingly, the present invention has developed a new design which can avoid the above-described drawbacks, can significantly enhance the performance of the devices and can take into account economic considerations. Therefore, the present invention then has been invented.

### SUMMARY OF THE INVENTION

The main technical problems that the present invention is seeking to solve is how to design a communication system with echo cancellation and an operation method thereof to reduce the cost of the software and hardware of the audio signal processing portion and reduce the power consumption.

In order to solve the above described problems and to achieve the expected effect, the present invention provides a voice communication system with echo cancellation, which comprises a first transceiver device and a second transceiver device. The first transceiver device comprises a first communication portion, an audio signal processing portion, a first sound generating portion and a first sound capturing portion. The second transceiver device comprises a second communication portion, a second sound generating portion and a second sound capturing portion. A first connection is established between the first communication portion of the first transceiver device and the second communication portion of the second transceiver device. The first sound capturing portion is used for capturing sound to output a first residual echo signal to the audio signal processing portion. The audio signal processing portion cancels echo from the first residual echo signal to output a first echo-cancelled signal to the first communication portion. The first echo-cancelled signal is transmitted from the first communication portion of the first transceiver device to the second communication portion of the second transceiver device through the first connection, and then the first echo-cancelled signal is transmitted to the second sound generating portion for generating an audio signal by the second sound generating portion. The second sound capturing portion is used for capturing sound to output a second residual echo signal to the second communication portion. The second residual echo signal is transmitted from the second communication portion of the second transceiver device to the first communication portion of the first transceiver device through the first connection, and then the second residual echo signal is transmitted to the audio signal processing portion. The audio signal processing portion cancels echo from the second residual echo signal to output a second echo-cancelled signal to the first sound generating portion for generating an audio signal by the first sound generating portion. In the voice communication system with echo cancellation provided by the present invention, only the first transceiver device has the audio signal processing portion, while the second transceiver device does not have the audio signal processing portion, so that the audio signal processing portion cost of software and hardware for the can be saved. Since the second transceiver device does not have the audio signal processing portion, the power consumption can be greatly reduced.

In implementation, the audio signal processing portion cancels echo from the second residual echo signal based on an adaptive filter parameter.

In implementation, when the second transceiver device is placed at a testing position in a testing space with no external sound interference, a plurality of non-identical testing input signals is transmitted to the second sound generating portion respectively for generating an audio signal by the second sound generating portion, the second sound capturing portion captures sound to output a plurality of testing feedback signals respectively, wherein the plurality of testing feedback signals is corresponding to the plurality of testing input signals, wherein the adaptive filter parameter is calculated from the plurality of testing input signals and the plurality of testing feedback signals.

In implementation, when the second transceiver device is placed at a first testing position in a testing space with no external sound interference, a plurality of non-identical first testing input signals is transmitted to the second sound generating portion respectively for generating an audio signal by the second sound generating portion, the second sound capturing portion captures sound to output a plurality of first testing feedback signals respectively, wherein the plurality of first testing feedback signals is corresponding to the plurality of first testing input signals; wherein when the second transceiver device is placed at a second testing position in the testing space with no external sound interference, a plurality of non-identical second testing input signals is transmitted to the second sound generating portion respectively for generating an audio signal by the second sound generating portion, the second sound capturing portion captures sound to output a plurality of second testing feedback signals respectively, wherein the plurality of second testing feedback signals is corresponding to the plurality of second testing input signals, wherein the adaptive filter parameter is calculated from the plurality of first testing feedback signals, the plurality of first testing input signals, the plurality of second testing feedback signals, and the plurality of second testing input signals.

In implementation, when the second transceiver device is placed at a first testing position in a first testing space with no external sound interference, a plurality of non-identical first testing input signals is transmitted to the second sound generating portion respectively for generating an audio signal by the second sound generating portion, the second sound capturing portion captures sound to output a plurality of first testing feedback signals respectively, wherein the plurality of first testing feedback signals is corresponding to the plurality of first testing input signals; wherein when the second transceiver device is placed at a second testing position in a second testing space with no external sound interference, a plurality of non-identical second testing input signals is transmitted to the second sound generating portion respectively for generating an audio signal by the second sound generating portion, the second sound capturing portion captures sound to output a plurality of second testing feedback signals respectively, wherein the plurality of second testing feedback signals is corresponding to the plurality of second testing input signals, wherein the adaptive filter parameter is calculated from the plurality of first testing feedback signals, the plurality of first testing input signals, the plurality of second testing feedback signals, and the plurality of second testing input signals.

In implementation, when the second transceiver device is placed at a first testing position in a first testing space with no external sound interference, a plurality of non-identical first testing input signals is transmitted to the second sound generating portion respectively for generating an audio signal by the second sound generating portion, the second sound capturing portion captures sound to output a plurality of first testing feedback signals respectively, wherein the plurality of first testing feedback signals is corresponding to the plurality of first testing input signals; wherein when the second transceiver device is placed at a second testing position in the first testing space with no external sound interference, a plurality of non-identical second testing input signals is transmitted to the second sound generating portion respectively for generating an audio signal by the second sound generating portion, the second sound capturing portion captures sound to output a plurality of second testing feedback signals respectively, wherein the plurality of second testing feedback signals is corresponding to the plurality of second testing input signals; wherein when the second transceiver device is placed at a third testing position in a second testing space with no external sound interference, a plurality of non-identical third testing input signals is transmitted to the second sound generating portion respectively for generating an audio signal by the second sound generating portion, the second sound capturing portion captures sound to output a plurality of third testing feedback signals respectively, wherein the plurality of third testing feedback signals is corresponding to the plurality of third testing input signals, wherein the adaptive filter parameter is calculated from the plurality of first testing feedback signals, the plurality of first testing input signals, the plurality of second testing feedback signals, the plurality of second testing input signals, the plurality of third testing feedback signals, and the plurality of third testing input signals.

In implementation, when the second transceiver device is placed at a first testing position in a first testing space with no external sound interference, a plurality of non-identical first testing input signals is transmitted to the second sound generating portion respectively for generating an audio signal by the second sound generating portion, the second sound capturing portion captures sound to output a plurality of first testing feedback signals respectively, wherein the plurality of first testing feedback signals is corresponding to the plurality of first testing input signals; wherein when the second transceiver device is placed at a second testing position in the first testing space with no external sound interference, a plurality of non-identical second testing input signals is transmitted to the second sound generating portion respectively for generating an audio signal by the second sound generating portion, the second sound capturing portion captures sound to output a plurality of second testing feedback signals respectively, wherein the plurality of second testing feedback signals is corresponding to the plurality of second testing input signals; wherein when the second transceiver device is placed at a third testing position in a second testing space with no external sound interference, a plurality of non-identical third testing input signals is transmitted to the second sound generating portion respectively for generating an audio signal by the second sound generating portion, the second sound capturing portion captures sound to output a plurality of third testing feedback signals respectively, wherein the plurality of third testing feedback signals is corresponding to the plurality of third testing input signals; wherein when the second transceiver device is placed at a fourth testing position in the second testing space with no external sound interference, a plurality of non-identical fourth testing input signals is transmitted to the second sound generating portion respectively for generating an audio signal by the second sound generating portion, the second sound capturing portion captures sound to output a plurality of fourth testing feedback signals respectively, wherein the plurality of fourth testing feedback signals is corresponding to the plurality of fourth testing input signals, wherein the adaptive filter parameter is calculated from the plurality of first testing feedback signals, the plurality of first testing input signals, the plurality of second testing feedback signals, the plurality of second testing input signals, the plurality of third testing feedback signals, the plurality of third testing input signals, the plurality of fourth testing feedback signals, and the plurality of fourth testing input signals.

In implementation, the adaptive filter parameter is stored in a server, the adaptive filter parameter is transmitted from the server to the first communication portion of the first transceiver device through a second connection established between the first communication portion of the first transceiver device and the server, and then the adaptive filter parameter is transmitted to the audio signal processing portion.

Moreover, the present invention further provides an operation method of voice communication system with echo cancellation, comprising following steps of: establishing a first connection between a first communication portion of a first transceiver device and a second communication portion of a second transceiver device; capturing sound by a first sound capturing portion of the first transceiver device to output a first residual echo signal to an audio signal processing portion of the first transceiver device; cancelling echo from the first residual echo signal by the audio signal processing portion to output a first echo-cancelled signal to the first communication portion; transmitting the first echo-cancelled signal from the first communication portion of the first transceiver device to the second communication portion of the second transceiver device through the first connection; transmitting the first echo-cancelled signal from the second communication portion to a second sound generating portion of the second transceiver device for generating an audio signal by the second sound generating portion; capturing sound by a second sound capturing portion of the second transceiver device to output a second residual echo signal to the second communication portion; transmitting the second residual echo signal from the second communication portion of the second transceiver device to the first communication portion of the first transceiver device through the first connection; transmitting the second residual echo signal from the first communication portion to the audio signal processing portion; and cancelling echo from the second residual echo signal by the audio signal processing portion to output a second echo-cancelled signal to a first sound generating portion of the first transceiver device for generating an audio signal by the first sound generating portion.

In implementation, the audio signal processing portion cancels echo from the second residual echo signal based on an adaptive filter parameter.

In implementation, the operation method further comprises a learning step, the learning step comprises following steps of: placing the second transceiver device at a testing position in a testing space with no external sound interference; transmitting a plurality of non-identical testing input signals to the second sound generating portion respectively for generating an audio signal by the second sound generating portion; capturing sound by the second sound capturing portion to output a plurality of testing feedback signals respectively, wherein the plurality of testing feedback signals is corresponding to the plurality of testing input signals; and calculating the adaptive filter parameter from the plurality of testing feedback signals and the plurality of testing input signals.

In implementation, the operation method further comprises a learning step, the learning step comprises following steps of: placing the second transceiver device at a first testing position in a testing space with no external sound interference; transmitting a plurality of non-identical first testing input signals to the second sound generating portion respectively for generating an audio signal by the second sound generating portion; capturing sound by the second sound capturing portion to output a plurality of first testing feedback signals respectively, wherein the plurality of first testing feedback signals is corresponding to the plurality of first testing input signals; placing the second transceiver device at a second testing position in the testing space with no external sound interference; transmitting a plurality of non-identical second testing input signals to the second sound generating portion respectively for generating an audio signal by the second sound generating portion; capturing sound by the second sound capturing portion to output a plurality of second testing feedback signals respectively, wherein the plurality of second testing feedback signals is corresponding to the plurality of second testing input signals; and calculating the adaptive filter parameter from the plurality of first testing feedback signals, the plurality of first testing input signals, the plurality of second testing feedback signals, and the plurality of second testing input signals.

In implementation, the plurality of second testing input signals is identical to the plurality of first testing input signals.

In implementation, the operation method further comprises a learning step, the learning step comprises following steps of: placing the second transceiver device at a first testing position in a first testing space with no external sound interference; transmitting a plurality of non-identical first testing input signals to the second sound generating portion respectively for generating an audio signal by the second sound generating portion; capturing sound by the second sound capturing portion to output a plurality of first testing feedback signals respectively, wherein the plurality of first testing feedback signals is corresponding to the plurality of first testing input signals; placing the second transceiver device at a second testing position in a second testing space with no external sound interference; transmitting a plurality of non-identical second testing input signals to the second sound generating portion respectively for generating an audio signal by the second sound generating portion; capturing sound by the second sound capturing portion to output a plurality of second testing feedback signals respectively, wherein the plurality of second testing feedback signals is corresponding to the plurality of second testing input signals; and calculating the adaptive filter parameter from the plurality of first testing feedback signals, the plurality of first testing input signals, the plurality of second testing feedback signals, and the plurality of second testing input signals.

In implementation, the plurality of second testing input signals is identical to the plurality of first testing input signals.

In implementation, the operation method further comprises a learning step, the learning step comprises following steps of: placing the second transceiver device at a first testing position in a first testing space with no external sound interference; transmitting a plurality of non-identical first testing input signals to the second sound generating portion respectively for generating an audio signal by the second sound generating portion; capturing sound by the second sound capturing portion to output a plurality of first testing feedback signals respectively, wherein the plurality of first testing feedback signals is corresponding to the plurality of first testing input signals; placing the second transceiver device at a second testing position in the first testing space with no external sound interference; transmitting a plurality of non-identical second testing input signals to the second sound generating portion respectively for generating an audio signal by the second sound generating portion; capturing sound by the second sound capturing portion to output a plurality of second testing feedback signals respectively, wherein the plurality of second testing feedback signals is corresponding to the plurality of second testing input signals; placing the second transceiver device at a third testing position in a second testing space with no external sound interference; transmitting a plurality of non-identical third testing input signals to the second sound generating portion respectively for generating an audio signal by the second sound generating portion; capturing sound by the second sound capturing portion to output a plurality of third testing feedback signals respectively, wherein the plurality of third testing feedback signals is corresponding to the plurality of third testing input signals; and calculating the adaptive filter parameter from the plurality of first testing feedback signals, the plurality of first testing input signals, the plurality of second testing feedback signals, the plurality of second testing input signals, the plurality of third testing feedback signals, and the plurality of third testing input signals.

In implementation, the plurality of second testing input signals is identical to the plurality of first testing input signals, the plurality of third testing input signals is identical to the plurality of first testing input signals.

In implementation, the operation method further comprises a learning step, the learning step comprises following steps of: placing the second transceiver device at a first testing position in a first testing space with no external sound interference; transmitting a plurality of non-identical first testing input signals to the second sound generating portion respectively for generating an audio signal by the second sound generating portion; capturing sound by the second sound capturing portion to output a plurality of first testing feedback signals respectively, wherein the plurality of first testing feedback signals is corresponding to the plurality of first testing input signals placing the second transceiver device at a second testing position in the first testing space with no external sound interference; transmitting a plurality of non-identical second testing input signals to the second sound generating portion respectively for generating an audio signal by the second sound generating portion; capturing sound by the second sound capturing portion to output a plurality of second testing feedback signals respectively, wherein the plurality of second testing feedback signals is corresponding to the plurality of second testing input signals; placing the second transceiver device at a third testing position in a second testing space with no external sound interference; transmitting a plurality of non-identical third testing input signals to the second sound generating portion respectively for generating an audio signal by the second sound generating portion; capturing sound by the second sound capturing portion to output a plurality of third testing feedback signals respectively, wherein the plurality of third testing feedback signals is corresponding to the plurality of third testing input signals; placing the second transceiver device at a fourth testing position in the second testing space with no external sound interference; transmitting a plurality of non-identical fourth testing input signals to the second sound generating portion respectively for generating an audio signal by the second sound generating portion; capturing sound by the second sound capturing portion to output a plurality of fourth testing feedback signals respectively, wherein the plurality of fourth testing feedback signals is corresponding to the plurality of fourth testing input signals; and calculating the adaptive filter parameter from the plurality of first testing feedback signals, the plurality of first testing input signals, the plurality of second testing feedback signals, the plurality of second testing input signals, the plurality of third testing feedback signals, the plurality of third testing input signals, the plurality of fourth testing feedback signals, and the plurality of fourth testing input signals.

In implementation, the plurality of second testing input signals is identical to the plurality of first testing input signals, the plurality of third testing input signals is identical to the plurality of first testing input signals, the plurality of fourth testing input signals is identical to the plurality of first testing input signals.

In implementation, the operation method further comprise following steps of: establishing a second connection between the first communication portion of the first transceiver device and a server; transmitting the adaptive filter parameter from the server to the first communication portion of the first transceiver device through the second connection, wherein the adaptive filter parameter is stored in the server; and transmitting the adaptive filter parameter from the server to the first communication portion to the audio signal processing portion.

Moreover, the present invention further provides a transceiver device with echo cancellation, which comprises a first communication portion, an audio signal processing portion, a first sound generating portion and a first sound capturing portion. The first sound capturing portion captures sound to output a first residual echo signal to the audio signal processing portion. The audio signal processing portion cancels echo from the first residual echo signal to output a first echo-cancelled signal to the first communication portion. The first echo-cancelled signal is transmitted from the first communication portion of the transceiver device to a second communication portion of a second transceiver device through a first connection established between the first communication portion and the second communication portion, and then to a second sound generating portion of the second transceiver device for generating an audio signal by the second sound generating portion. The second communication portion of the second transceiver device transmits a second residual echo signal outputted by a second sound capturing portion of the second transceiver device to the first communication portion of the transceiver device through the first connection, and then to the audio signal processing portion. The audio signal processing portion cancels echo from the second residual echo signal to output a second echo-cancelled signal to the first sound generating portion for generating an audio signal by the first sound generating portion.

In implementation, the audio signal processing portion cancels echo from the second residual echo signal based on an adaptive filter parameter.

In implementation, the adaptive filter parameter is stored in a server, the adaptive filter parameter is transmitted from the server to the first communication portion of the transceiver device through a second connection established between the first communication portion of the transceiver device and the server, and then to the audio signal processing portion.

For further understanding the characteristics and effects of the present invention, some preferred embodiments referred to drawings are in detail described as follows.

### BRIEF DESCRIPTION OF DRAWINGS

FIG. 1 is a schematic view showing an embodiment of a voice communication system with echo cancellation of the present invention.

FIG. 2 is a schematic view showing a learning step of an operation method of voice communication system with echo cancellation of the present invention.

FIG. 3 is a schematic view showing another learning step of the operation method of voice communication system with echo cancellation of the present invention.

FIG. 4 is a schematic view showing another embodiment of the voice communication system with echo cancellation of the present invention.

FIG. 5 is a schematic view of an echo cancellation communication system of the conventional technology.

### DETAILED DESCRIPTIONS OF PREFERRED EMBODIMENTS

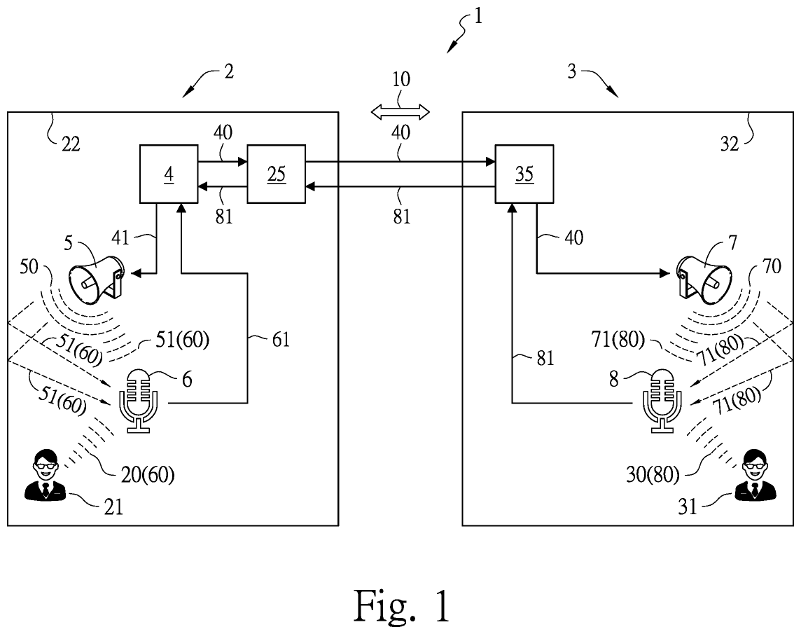

Please refer to FIG. 1, which is a schematic view showing an embodiment of a voice communication system with echo cancellation of the present invention. The present invention provides a voice communication system 1 with echo cancellation, which comprises a first transceiver device 2 and a second transceiver device 3. The first transceiver device 2 comprises a first communication portion 25, a first sound generating portion 5, a first sound capturing portion 6 and an audio signal processing portion 4, wherein the audio signal processing portion 4 is connected to the first sound generating portion 5, the first sound capturing portion 6 and the first communication portion 25 respectively. The second transceiver device 3 comprises a second communication portion 35, a second sound generating portion 7 and a second sound capturing portion 8, wherein the second communication portion 35 is connected to the second sound generating portion 7 and the second sound capturing portion 8 respectively. The present invention further provides an operation method of the voice communication system 1 with echo cancellation, which comprises following steps of: Step A: establishing a first connection 10 between the first communication portion 25 of the first transceiver device 2 and the second communication portion 35 of the second transceiver device 3 for transmitting signals, wherein the first connection 10 may be wired, wireless, or a combination of wired and wireless network connection, or the first connection 10 may be a peer-to-peer network connection; Step B: outputting a first echo-cancelled signal 40 (electrical signal) by the audio signal processing portion 4 to the first communication portion 25, wherein the first echo-cancelled signal 40 (electrical signal) has been echo-cancelled by the audio signal processing portion 4; Step C: transmitting the first echo-cancelled signal 40 (electrical signal) from the first communication portion 25 of the first transceiver device 2 to the second communication portion 35 of the second transceiver device 3 through the first connection 10; Step D: transmitting the first echo-cancelled signal 40 (electrical signal) from the second communication portion 35 to the second sound generating portion 7; Step E: generating a second output audio signal 70 (sound) corresponding to the first echo-cancelled signal 40 (electrical signal) by the second sound generating portion 7; that is, the second sound generating portion 7 converts the first echo-cancelled signal 40 (electrical signal) into the second output audio signal 70 (sound); hence, the second output audio signal 70 (sound) generated by the second sound generating portion 7 and heard by a second user 31 in an environment 32 where the second transceiver device 3 is placed is the audio signal (sound) that has been echo-cancelled; Step F: capturing a second input audio signal 80 (sound) by the second sound capturing portion 8 to output a second residual echo signal 81 (electrical signal) corresponding to the second input audio signal 80 (sound) to the second communication portion 35; that is, the second sound capturing portion 8 captures the second input audio signal 80 (sound) and converts the second input audio signal 80 (sound) into the second residual echo signal 81 (electrical signal); wherein the second input audio signal 80 (sound) comprises a second external audio signal 30 (sound) and a second feedback audio signal 71 (sound), wherein the second feedback audio signal 71 (sound) is corresponding to the second output audio signal 70 (sound); due to the relative position of the second sound generating portion 7 and the second sound capturing portion 8, it is possible that a part of the second output audio signal 70 (sound) will be directly captured by the second sound capturing portion 8; it is also possible that a part of the second output audio signal 70 (sound) will be captured by the second sound capturing portion 8 after a single reflection or multiple reflections in the environment 32 where the second transceiver device 3 is placed; and the sum of the audio signal (sound) captured by the second sound capturing portion 8 and related to the second output audio signal 70 (sound) is the second feedback audio signal 71 (sound); wherein the second external audio signal 30 (sound) is other audio signal (signal) captured by the second sound capturing portion 8 and not related to the second output audio signal 70 (sound); the second external audio signal 30 (sound) may include the sound made by the second user 31 and other external audio signal (sound) in the environment 32 where the second transceiver device 3 is placed; for example, the surrounding noises, the sounds of neighboring people, objects, etc., may be partly captured by the second sound capturing portion 8; these all belong to the second external audio signal 30 (sound); Step G: transmitting the second residual echo signal 81 (electrical signal) from the second communication portion 35 of the second transceiver device 3 to the first communication portion 25 of the first transceiver device 2 through the first connection 10; Step H: transmitting the second residual echo signal 81 (electrical signal) from the first communication portion 25 to the audio signal processing portion 4; Step I: cancelling echo from the second residual echo signal 81 (electrical signal) by the audio signal processing portion 4 to output a second echo-cancelled signal 41 (electrical signal) to the first sound generating portion 5; Step J: generating a first output audio signal 50 (sound) corresponding to the second echo-cancelled signal 41 (electrical signal) by the first sound generating portion 5 of the first transceiver device 2; that is, the first sound generating portion 5 converts the second echo-cancelled signal 41 (electrical signal) into the first output audio signal 50 (sound); hence, the first output audio signal 50 (sound) generated by the first sound generating portion 5 and heard by a first user 21 in an environment 22 where the first transceiver device 2 is placed is the audio signal (sound) that has been echo-cancelled; Step K: capturing a first input audio signal 60 (sound) by the first sound capturing portion 6 to output a first residual echo signal 61 (electrical signal) corresponding to the first input audio signal 60 (sound) to the audio signal processing portion 4; that is, the first sound capturing portion 6 captures the first input audio signal 60 (sound) and converts the first input audio signal 60 (sound) into the first residual echo signal 61 (electrical signal); wherein the first input audio signal 60 (sound) comprises a first external audio signal 20 (sound) and a first feedback audio signal 51 (sound), wherein the first feedback audio signal 51 (sound) is corresponding to the first output audio signal 50 (sound); due to the relative position of the first sound generating portion 5 and the first sound capturing portion 6, it is possible that a part of the first output audio signal 50 (sound) will be directly captured by the first sound capturing portion 6; it is also possible that a part of the first output audio signal 50 (sound) will be captured by the first sound capturing portion 6 after a single reflection or multiple reflections in the environment 22 where the first transceiver device 2 is placed; and the sum of the audio signal (sound) captured by the first sound capturing portion 6 and related to the first output audio signal 50 (sound) is the first feedback audio signal 51 (sound); wherein the first external audio signal 20 (sound) is other audio signal (signal) captured by the first sound capturing portion 6 and not related to the first output audio signal 50 (sound); the first external audio signal 20 (sound) may include the sound made by the first user 21 and other external audio signal (sound) in the environment 22 where the first transceiver device 2 is placed; for example, the surrounding noises, the sounds of neighboring people, objects, etc., may be partly captured by the first sound capturing portion 6; these all belong to the first external audio signal 20 (sound); and Step L: cancelling echo from the first residual echo signal 61 (electrical signal) by the audio signal processing portion 4 to output the first echo-cancelled signal 40 (electrical signal) as in the Step B; as in the Step B, the Step C and the Step D, the first echo-cancelled signal 40 (electrical signal) is then transmitted to the first communication portion 25, and then the first echo-cancelled signal 40 (electrical signal) is transmitted to the second communication portion 35 of the second transceiver device 3 through the first connection 10, and then the first echo-cancelled signal 40 (electrical signal) is transmitted to the second sound generating portion 7. In the voice communication system 1 with echo cancellation provided by the present invention, only the first transceiver device 2 has the audio signal processing portion 4 for echo cancellation; while the second transceiver device 3 has no audio signal processing portion for echo cancellation, so that the cost of the software and hardware of the audio signal processing portion for echo cancellation can be saved. Furthermore, since the second transceiver device 3 has no audio signal processing portion for echo cancellation, the consumption of electric energy of the second transceiver device 3 can be greatly reduced. The signal (the second residual echo signal 81) transmitted from the second communication portion 35 of the second transceiver device 3 to the first communication portion 25 of the first transceiver device 2 through the first connection 10 has not yet been echo-cancelled; while the signal (the first echo-cancelled signal 40) transmitted from the first communication portion 25 of the first transceiver device 2 to the second communication portion 35 of the second transceiver device 3 through the first connection 10 has been echo-cancelled.

The first connection 10 established between the first communication portion 25 of the first transceiver device 2 and the second communication portion 35 of the second transceiver device 3 can be a peer-to-peer network connection (that is, under the network architecture of the first connection 10, the first transceiver device 2 and the second transceiver device 3 are peer-to-peer; it is not a client-server network architecture between the first transceiver device 2 and the second transceiver device 3). However, the voice communication system 1 with echo cancellation and its operation method of the present invention is featured in that the second transceiver device 3 has no audio signal processing portion for echo cancellation and only the first transceiver device 2 has the audio signal processing portion 4 for echo cancellation; hence, the signal (the first echo-cancelled signal 40) outputted by the audio signal processing portion 4 of the first transceiver device 2 is the signal (electrical signal) that has been echo-cancelled by the audio signal processing portion 4; while the signal (the second residual echo signal 81) outputted by the second sound capturing portion 8 of the second transceiver device 3 is the signal (electrical signal) that has not yet been echo-cancelled; and the second residual echo signal 81 that has not yet been echo-cancelled needs to be transmitted to the audio signal processing portion 4 of the first transceiver device 2 through the first connection 10 for echo cancellation. Hence, in terms of the function of echo cancellation, it is a client-server echo-cancellation-function architecture between the first transceiver device 2 and the second transceiver device 3, wherein the first transceiver device 2 having the audio signal processing portion 4 can be treated as a server with the function of echo cancellation; while the second transceiver device 3 having no audio signal processing portion can be treated as a client with no function of echo cancellation. Since the second transceiver device 3 (client) has no audio signal processing portion for echo cancellation, the second transceiver device 3 (client) needs to transmit the second residual echo signal 81 that has not yet been echo-cancelled to the audio signal processing portion 4 of the first transceiver device 2 through the first connection 10 (peer-to-peer network connection architecture) for echo cancellation; while the first echo-cancelled signal 40 that has been echo-cancelled by the audio signal processing portion 4 is outputted by the first transceiver device 2 (server) and transmitted to the second communication portion 35 and the second sound generating portion 7 of the second transceiver device 3 through the first connection 10 (peer-to-peer network connection architecture).

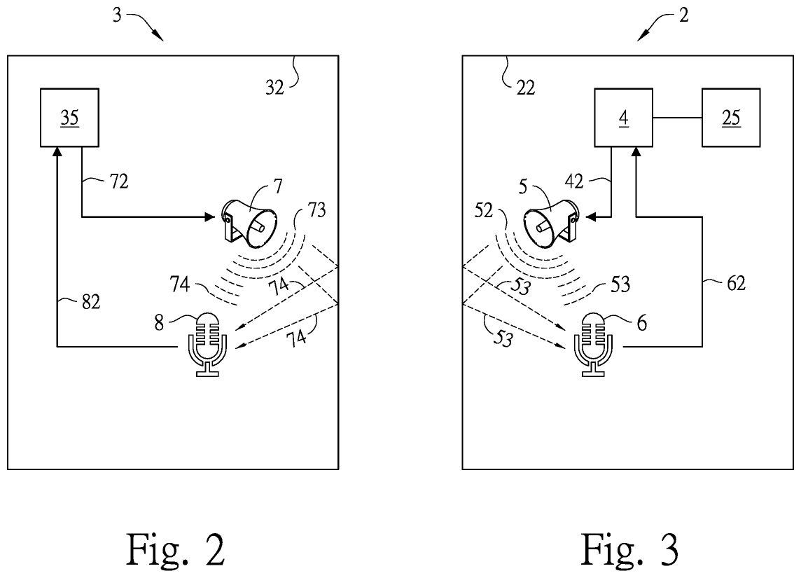

In some embodiments, the first transceiver device 2 is a normal cell phone. Hence, the audio signal processing portion 4 of the first transceiver device 2 can cancel echo from the first residual echo signal 61 outputted by the first sound capturing portion 6 of the first transceiver device 2. However, if the audio signal processing portion 4 of the first transceiver device 2 is required to cancel echo from the second residual echo signal 81 outputted by the second sound capturing portion 8 of the second transceiver device 3, then the audio signal processing portion 4 of the first transceiver device 2 must have the echo-related information of the second transceiver device 3 in order to cancel echo from the second residual echo signal 81. There are many well-known artificial intelligence echo cancellation methods. Some of the artificial intelligence echo cancellation methods obtain an adaptive filter parameter through a learning step, and cancel echo based on the adaptive filter parameter. The voice communication system 1 with echo cancellation and its operation method of the present invention may use these well-known artificial intelligence echo cancellation methods to obtain an adaptive filter parameter to achieve the object of using the audio signal processing portion 4 of the first transceiver device 2 to cancel echo from the second residual echo signal 81 outputted by the second sound capturing portion 8 of the second transceiver device 3. Please refer to FIG. 2, which is a schematic view showing a learning step of an operation method of voice communication system with echo cancellation of the present invention. The structure of the embodiment of FIG. 2 is the second transceiver device 3 of the embodiment of FIG. 1. The operation method of the voice communication system 1 with echo cancellation of the present invention further comprises a learning step in order to obtain a second adaptive filter parameter. The audio signal processing portion 4 of the first transceiver device 2 cancels echo from the second residual echo signal 81 based on the second adaptive filter parameter. During executing the learning step, there is no voice of human being, or the surrounding noise, sound of objects, etc. in the environment 32 where the second transceiver device 3 is placed; that is, there is no other external audio signal (sound) in the environment 32 where the second transceiver device 3 is placed. The learning step comprises following steps of: Step A0: transmitting a second testing input signal 72 (electrical signal) to the second sound generating portion 7 of the second transceiver device 3; Step A1: generating a second testing output audio signal 73 (sound) corresponding to the second testing input signal 72 (electrical signal) by the second sound generating portion 7 of the second transceiver device 3; Step A2: capturing a second testing feedback audio signal 74 (sound) by the second sound capturing portion 8 of the second transceiver device 3 to output a second testing feedback signal 82 (electrical signal) corresponding to the second testing feedback audio signal 74 (sound); wherein the second testing feedback audio signal 74 (sound) captured by the second sound capturing portion 8 of the second transceiver device 3 is corresponding to the second testing output audio signal 73 (sound), but not to other external audio signal (sound); that is, due to the relative position of the second sound generating portion 7 and the second sound capturing portion 8, it is possible that a part of the second testing output audio signal 73 (sound) will be directly captured by the second sound capturing portion 8; it is also possible that a part of the second testing output audio signal 73 (sound) will be captured by the second sound capturing portion 8 after a single reflection or multiple reflections in the environment 32 where the second transceiver device 3 is placed; and the sum of the audio signal (sound) captured by the second sound capturing portion 8 and corresponding to the second testing output audio signal 73 (sound) is the second testing feedback audio signal 74 (sound); however, there is no other external audio signal (sound) in the environment 32 where the second transceiver device 3 is placed, hence, the second sound capturing portion 8 of the second transceiver device 3 captures only the second testing feedback audio signal 74 but no other external audio signal (sound); Step A3: changing testing conditions and repeating the Step A0, the Step A1 and the Step A2 to collect the combinations of the second testing input signal 72 and the second testing feedback signal 82 under different testing conditions; wherein the above mentioned changing testing conditions may include at least one selected from the following group of testing conditions: (a) changing second testing input signals 72 (electrical signal), wherein it can be achieved by changing the second testing input signal 72 to be with different waveforms (for example, different frequencies, or combinations of different frequencies), changing the second testing input signal 72 to be with different amplitudes, or changing the second testing input signal 72 to be with different waveforms and different amplitudes; (b) changing positions of the second transceiver device 3 in the same environment 32, wherein when the position of the second transceiver device 3 in the same environment 32 is different, the second testing feedback audio signal 74 will be different; and (c) changing environments 32 by placing the second transceiver device 3 in different environments 32, wherein when the second transceiver device 3 is placed in different environment 32, the second testing feedback audio signal 74 will be different; and Step A4: calculating the second adaptive filter parameter from a plurality of combinations of a plurality of the second testing input signals 72 and a plurality of the second testing feedback signals 82 collected through the Step A0, the Step A1, the Step A2 and the Step A3, wherein the second adaptive filter parameter can be stored in the audio signal processing portion 4 of the first transceiver device 2. In the Step A3, the more times the Step A0, the Step A1 and the Step A2 are repeated, the more combinations of the second testing input signals 72 and the second testing feedback signals 82 are collected and the more helpful it is to obtain the more complete second adaptive filter parameter to improve the effect of echo cancellation when the audio signal processing portion 4 of the first transceiver device 2 cancels echo from the second residual echo signal 81.

In some embodiments, the above mentioned Step A3 may further comprises a following step of: Step A30: changing second testing input signals 72 (electrical signal) while the second transceiver device 3 is placed in the same position in the same environment 32, and repeating the Step A0, the Step A1 and the Step A2 to collect the combinations of the second testing input signal 72 and the second testing feedback signal 82 under different second testing input signals 72 (electrical signal).

In some other embodiments, the above mentioned Step A3 may further comprises following steps of: Step A30: changing second testing input signals 72 (electrical signal) while the second transceiver device 3 is placed in the same position in the same environment 32, and repeating the Step A0, the Step A1 and the Step A2 to collect the combinations of the second testing input signal 72 and the second testing feedback signal 82 under different second testing input signals 72 (electrical signal); and Step A31: changing positions of the second transceiver device 3 in the same environment 32, and repeating the Step A0, the Step A1, the Step A2, and the Step A30 to collect the combinations of the second testing input signal 72 and the second testing feedback signal 82 under different positions of the second transceiver device 3 in the same environment 32.

In some other embodiments, the above mentioned Step A3 may further comprises following steps of: Step A30: changing second testing input signals 72 (electrical signal) while the second transceiver device 3 is placed in the same position in the same environment 32, and repeating the Step A0, the Step A1 and the Step A2 to collect the combinations of the second testing input signal 72 and the second testing feedback signal 82 under different second testing input signals 72 (electrical signal); Step A31: changing positions of the second transceiver device 3 in the same environment 32, and repeating the Step A0, the Step A1, the Step A2, and the Step A30 to collect the combinations of the second testing input signal 72 and the second testing feedback signal 82 under different positions of the second transceiver device 3 in the same environment 32; and Step A32: changing environments 32 by placing the second transceiver device 3 in different environments 32, and repeating the Step A0, the Step A1, the Step A2, the Step A30, and the Step A31 to collect the combinations of the second testing input signal 72 and the second testing feedback signal 82 under different environments 32 where the second transceiver device 3 is placed.

In some embodiments, the audio signal processing portion 4 of the first transceiver device 2 can use hardware, software, or software with hardware to cancel echo from the first residual echo signal 61 outputted by the first sound capturing portion 6 of the first transceiver device 2. In some other embodiments, the audio signal processing portion 4 of the first transceiver device 2 can use some real-time echo cancellation methods to cancel echo from the first residual echo signal 61.

In some embodiments, the first transceiver device 2 can also use the echo cancellation methods of artificial intelligence to obtain an adaptive filter parameter through a learning step, so that the audio signal processing portion 4 of the first transceiver device 2 can cancel echo from the first residual echo signal 61 outputted by the first sound capturing portion 6 of the first transceiver device 2 based on the adaptive filter parameter. Please refer to FIG. 3, which is a schematic view showing another learning step of the operation method of voice communication system with echo cancellation of the present invention. The structure of the embodiment of FIG. 3 is the first transceiver device 2 of the embodiment of FIG. 1. The operation method of the voice communication system 1 with echo cancellation of the present invention further comprises a learning step for obtaining a first adaptive filter parameter, wherein the audio signal processing portion 4 of the first transceiver device 2 cancels echo from the first residual echo signal 61 based on the first adaptive filter parameter. During performing the learning step, there is no voice of human being, or the surrounding noise, sound of objects, etc. in the environment 22 where the first transceiver device 2 is placed; that is, there is no other external audio signal (sound) in the environment 22 where the first transceiver device 2 is placed. The learning step comprises following steps of: Step A10: transmitting a first testing input signal 42 (electrical signal) to the first sound generating portion 5 of the first transceiver device 2; Step A11: generating a first testing output audio signal 52 (sound) corresponding to the first testing input signal 42 (electrical signal) by the first sound generating portion 5 of the first transceiver device 2; Step A12: capturing a first testing feedback audio signal 53 (sound) by the first sound capturing portion 6 of the first transceiver device 2 to output a first testing feedback signal 62 (electrical signal) corresponding to the first testing feedback audio signal 53 (sound); wherein the first testing feedback audio signal 53 (sound) captured by the first sound capturing portion 6 of the first transceiver device 2 is corresponding to the first testing output audio signal 52 (sound), but no other external audio signal (sound); that is, due to the relative position of the first sound generating portion 5 and the first sound capturing portion 6, it is possible that a part of the first testing output audio signal 52 (sound) will be directly captured by the first sound capturing portion 6; it is also possible that a part of the first testing output audio signal 52 (sound) will be captured by the first sound capturing portion 6 after a single reflection or multiple reflections in the environment 22 where the first transceiver device 2 is placed; and the sum of the audio signal (sound) captured by the first sound capturing portion 6 and corresponding to the first testing output audio signal 52 (sound) is the first testing feedback audio signal 53 (sound); however, there is no other external audio signal (sound) in the environment 22 where the first transceiver device 2 is placed, hence, the first sound capturing portion 6 of the first transceiver device 2 captures only the first testing feedback audio signal 53, but no other external audio signal (sound); Step A13: changing testing conditions and repeating the Step A10, the Step A11 and the Step A12 to collect the combinations of the first testing input signal 42 and the first testing feedback signal 62 under different testing conditions; wherein the above mentioned changing testing conditions may include at least one selected from the following group of testing conditions: (a) changing first testing input signals 42 (electrical signal), wherein it can be achieved by changing the first testing input signal 42 to be with different waveforms (for example, different frequencies, or combinations of different frequencies), changing the first testing input signal 42 to be with different amplitudes, or changing the first testing input signal 42 to be with different waveforms and different amplitudes; (b) changing positions of the first transceiver device 2 in the same environment 22, wherein when the position of the first transceiver device 2 in the same environment 22 is different, the first testing feedback audio signal 53 will be different; and (c) changing environments 22 by placing the first transceiver device 2 in different environments 22, wherein when the first transceiver device 2 is placed in different environment 22, the first testing feedback audio signal 53 will be different; and Step A14: calculating the first adaptive filter parameter from a plurality of combinations of a plurality of the first testing input signal 42 and a plurality of the first testing feedback signal 62 collected through the Step A10, the Step A11, the Step A12 and the Step A13, wherein the first adaptive filter parameter can be stored in the audio signal processing portion 4 of the first transceiver device 2. In the Step A13, the more times the Step A10, the Step A11 and the Step A12 are repeated, the more combinations of the first testing input signal 42 and the first testing feedback signal 62 are collected and the more helpful it is to obtain the more complete first adaptive filter parameter to improve the effect of echo cancellation when the audio signal processing portion 4 of the first transceiver device 2 cancels echo from the first residual echo signal 61.

In some embodiments, the above mentioned Step A13 may further comprises a following step of: Step A130: changing first testing input signals 42 (electrical signal) while the first transceiver device 2 is placed in the same position in the same environment 22, and repeating the Step A10, the Step A11 and the Step A12 to collect the combinations of the first testing input signals 42 and the first testing feedback signal 62 under different first testing input signals 42 (electrical signal). In some other embodiments, the above mentioned Step A13 may further comprises following steps of: Step A130: changing first testing input signals 42 while the first transceiver device 2 is placed in the same position in the same environment 22, and repeating the Step A10, the Step A11 and the Step A12 to collect the combinations of the first testing input signals 42 and the first testing feedback signal 62 under different first testing input signals 42; and Step 131: changing positions of the first transceiver device 2 in the same environment 22, and repeating the Step A10, the Step A11, the Step A12, and the Step A130 to collect the combinations of the first testing input signals 42 and the first testing feedback signal 62 under different positions of the first transceiver device 2 in the same environment 22. In some other embodiments, the above mentioned Step A13 may further comprises following steps of: Step A130: changing first testing input signals 42 (electrical signal) while the first transceiver device 2 is placed in the same position in the same environment 22, and repeating the Step A10, the Step A11 and the Step A12 to collect the combinations of the first testing input signals 42 and the first testing feedback signal 62 under different first testing input signals 42 (electrical signal); Step A131: changing positions of the first transceiver device 2 in the same environment 22, and repeating the Step A10, the Step A11, the Step A12, and the Step A130 to collect the combinations of the first testing input signals 42 and the first testing feedback signal 62 under different positions of the first transceiver device 2 in the same environment 22; and Step A132: changing environments 22 by placing the first transceiver device 2 in different environments 22, and repeating the Step A10, the Step A11, the Step A12, the Step A130, and the Step A131 to collect the combinations of the first testing input signals 42 and the first testing feedback signal 62 under different environments 22 where the first transceiver device 2 is placed.

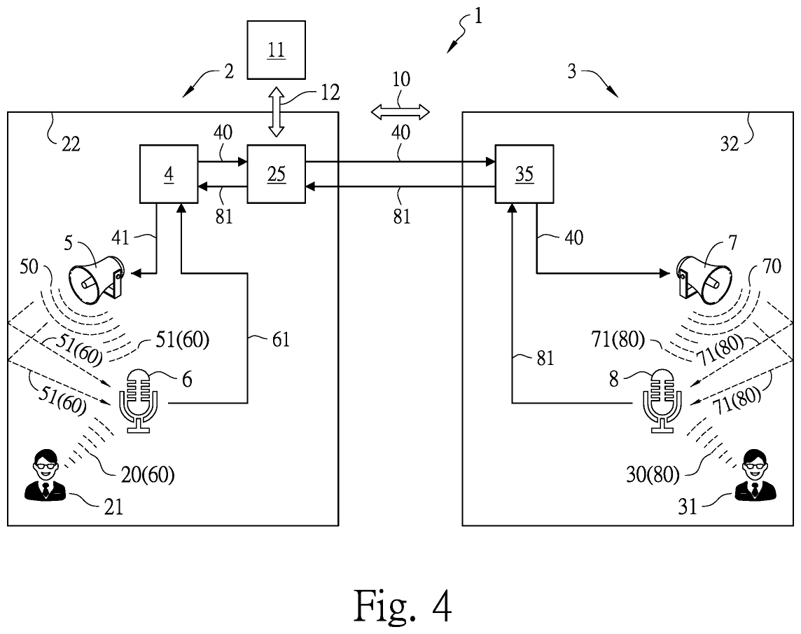

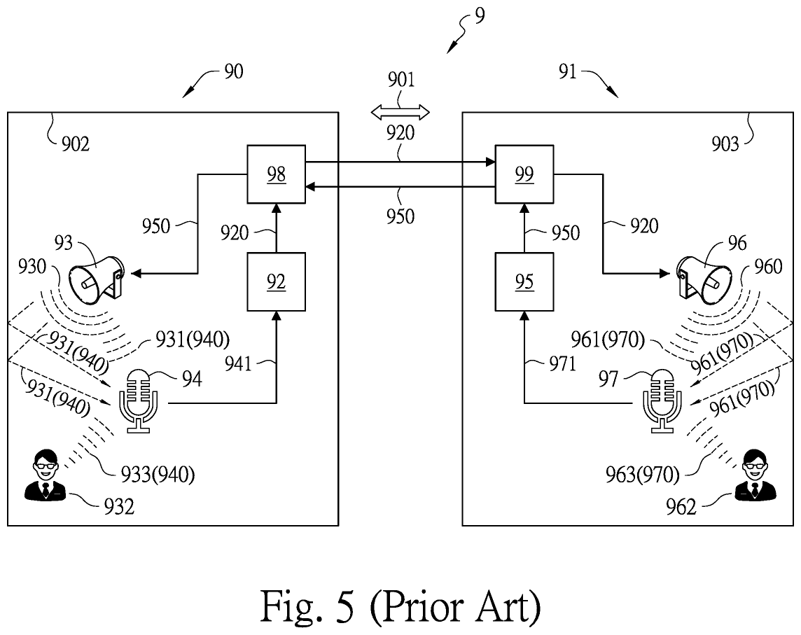

Please refer to FIG. 4, which is a schematic view showing another embodiment of the voice communication system with echo cancellation of the present invention. The main structure of the embodiment of FIG. 4 is basically the same as the structure of the embodiment of FIG. 1, except that a second connection 12 can be established between the first communication portion 25 of the first transceiver device 2 and a server 11, wherein the second adaptive filter parameter is stored in the server 11; the second adaptive filter parameter is transmitted from the server 11 to the first communication portion 25 of the first transceiver device 2 through the second connection 12, and then the second adaptive filter parameter is transmitted to the audio signal processing portion 4 of the first transceiver device 2. The operation method of the voice communication system 1 with echo cancellation of the present invention further comprises following steps of: establishing the second connection 12 between the first communication portion 25 of the first transceiver device 2 and the server 11; and transmitting the second adaptive filter parameter from the server 11 to the first communication portion 25 of the first transceiver device 2 through the second connection 12, and then transmitting the second adaptive filter parameter to the audio signal processing portion 4 of the first transceiver device 2. The audio signal processing portion 4 of the first transceiver device 2 cancels echo from the second residual echo signal 81 (electrical signal) based on the second adaptive filter parameter.

In some embodiments, the first adaptive filter parameter is also stored in the server 11; the first adaptive filter parameter is transmitted from the server 11 to the first communication portion 25 of the first transceiver device 2 through the second connection 12, and then the first adaptive filter parameter is transmitted to the audio signal processing portion 4 of the first transceiver device 2. The operation method of the voice communication system 1 with echo cancellation of the present invention further comprises following steps of: establishing the second connection 12 between the first communication portion 25 of the first transceiver device 2 and the server 11; and transmitting the first adaptive filter parameter from the server 11 to the first communication portion 25 of the first transceiver device 2 through the second connection 12, and then transmitting the first adaptive filter parameter to the audio signal processing portion 4 of the first transceiver device 2. The audio signal processing portion 4 of the first transceiver device 2 cancels echo from the first residual echo signal 61 (electrical signal) based on the first adaptive filter parameter.

In a preferred embodiment, the present invention provides a voice communication system 1 with echo cancellation, wherein the second transceiver device 3 is specially provided for the care recipients (such as the elderly, or people with limited mobility) to communicate with the caregivers (such as the caregivers in the long-term care center). The second transceiver device 3 does not have the audio signal processing portion; hence, it has no function of echo cancellation. The first transceiver device 2 used by the caregivers is a normal mobile phone, in which the second adaptive filter parameter is stored in the audio signal processing portion 4 of the first transceiver device 2 (or, as shown in the embodiment of FIG. 4, the second adaptive filter parameter is stored in the server 11, and then the second adaptive filter parameter is downloaded from the server 11 to the audio signal processing portion 4 of the first transceiver device 2). Hence, the audio signal processing portion 4 of the first transceiver device 2 (the caregiver) can cancel echo from the second residual echo signal 81 outputted by the second sound capturing portion 8 of the second transceiver device 3 (the care recipient) based on the second adaptive filter parameter. Since the second transceiver device 3 is specially provided for the care recipient to communicate with the caregiver, the best design of the second transceiver device 3 is that the care recipient can just press a button to establish the first connection 10 between the first communication portion 25 of the first transceiver device 2 (the caregiver) and the second communication portion 35 of the second transceiver device 3 (care recipient). And because the care recipients are mostly elderly people or people with limited mobility, and even the care recipients are mostly alone or at home for a long time, the best design of the second transceiver device 3 (care recipient) is power saving and having a long standby time. In this way, the care recipient does not need to pay attention to whether the second transceiver device 3 is fully charged at any time, and does not need to charge at any time. Therefore, in the design of the present invention, the second transceiver device 3 does not have an audio signal processing portion, so it does not have the function of echo cancellation. As a result, even if the second transceiver device 3 (care recipient) talks to the first transceiver device 2 (the caregiver) for a long time, it (the second transceiver device 3) will save power compared to the general transceiver device with the audio signal processing portion (such as mobile phone), and the power consumption can be saved a lot. In addition, the manufacturing cost of the second transceiver device 3 can be greatly reduced, and the burden on the user can be greatly reduced.

In another preferred embodiment, the personnel who have been stationed outside for a long time to conduct surveys will need to contact the control center at any time according to the situation to report on-site conditions. Generally, the dispatched personnel and the control center will use mobile phones or radio walkie-talkies to make contact. However, in current embodiment, it (the mobile phone) is very suitable to be replaced by the second transceiver device 3 of the present invention. The dispatched personnel use the second transceiver device 3 and contact the control center (the first transceiver device 2) at any time as needed to report on-site conditions. The second transceiver device 3 does not have an audio signal processing portion, so it does not have the function of echo cancellation. As a result, even if the second transceiver device 3 (expatriate) talks to the first transceiver device 2 (control center) for a long time, it (the second transceiver device 3) will save power compared to ordinary mobile phones or radio walkie-talkies, and the power consumption can be saved a lot. In addition, the manufacturing cost of the second transceiver device 3 can be greatly reduced, and the burden on the user can be greatly reduced.

As disclosed in the above description and attached drawings, the present invention can provide a voice communication system with echo cancellation and an operation method thereof. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. An operation method of a voice communication system with echo cancellation, comprising following steps of:
establishing a first connection between a first communication portion of a first transceiver device and a second communication portion of a second transceiver device;
capturing sound by a first sound capturing portion of said first transceiver device to output a first residual echo signal to an audio signal processing portion of said first transceiver device;
cancelling echo from said first residual echo signal by said audio signal processing portion to output a first echo-cancelled signal to said first communication portion;
transmitting said first echo-cancelled signal from said first communication portion of said first transceiver device to said second communication portion of said second transceiver device through said first connection;
transmitting said first echo-cancelled signal from said second communication portion to a second sound generating portion of said second transceiver device for generating an audio signal by said second sound generating portion;
capturing sound by a second sound capturing portion of said second transceiver device to output a second residual echo signal to said second communication portion;
transmitting said second residual echo signal from said second communication portion of said second transceiver device to said first communication portion of said first transceiver device through said first connection;
transmitting said second residual echo signal from said first communication portion to said audio signal processing portion; and
cancelling echo from said second residual echo signal by said audio signal processing portion to output a second echo-cancelled signal to a first sound generating portion of said first transceiver device for generating an audio signal by said first sound generating portion.

2. The operation method of the voice communication system with echo cancellation according to claim 1, wherein said audio signal processing portion cancels echo from said second residual echo signal based on an adaptive filter parameter.

3. The operation method of the voice communication system with echo cancellation according to claim 2, further comprising a learning step, said learning step comprises following steps of:
placing said second transceiver device at a testing position in a testing space with no external sound interference;
transmitting a plurality of non-identical testing input signals to said second sound generating portion respectively for generating an audio signal by said second sound generating portion;
capturing sound by said second sound capturing portion to output a plurality of testing feedback signals respectively, wherein said plurality of testing feedback signals is corresponding to said plurality of testing input signals; and
calculating said adaptive filter parameter from said plurality of testing feedback signals and said plurality of testing input signals.

4. The operation method of the voice communication system with echo cancellation according to claim 2, further comprising a learning step, said learning step comprises following steps of:
placing said second transceiver device at a first testing position in a testing space with no external sound interference;
transmitting a plurality of non-identical first testing input signals to said second sound generating portion respectively for generating an audio signal by said second sound generating portion;
capturing sound by said second sound capturing portion to output a plurality of first testing feedback signals respectively, wherein said plurality of first testing feedback signals is corresponding to said plurality of first testing input signals;
placing said second transceiver device at a second testing position in said testing space with no external sound interference;
transmitting a plurality of non-identical second testing input signals to said second sound generating portion respectively for generating an audio signal by said second sound generating portion;
capturing sound by said second sound capturing portion to output a plurality of second testing feedback signals respectively, wherein said plurality of second testing feedback signals is corresponding to said plurality of second testing input signals; and
calculating said adaptive filter parameter from said plurality of first testing feedback signals, said plurality of first testing input signals, said plurality of second testing feedback signals, and said plurality of second testing input signals.

5. The operation method of the voice communication system with echo cancellation according to claim 4, wherein said plurality of second testing input signals is identical to said plurality of first testing input signals.

6. The operation method of the voice communication system with echo cancellation according to claim 2, further comprising a learning step, said learning step comprises following steps of:
placing said second transceiver device at a first testing position in a first testing space with no external sound interference;
transmitting a plurality of non-identical first testing input signals to said second sound generating portion respectively for generating an audio signal by said second sound generating portion;
capturing sound by said second sound capturing portion to output a plurality of first testing feedback signals respectively, wherein said plurality of first testing feedback signals is corresponding to said plurality of first testing input signals;
placing said second transceiver device at a second testing position in a second testing space with no external sound interference;
transmitting a plurality of non-identical second testing input signals to said second sound generating portion respectively for generating an audio signal by said second sound generating portion;
capturing sound by said second sound capturing portion to output a plurality of second testing feedback signals respectively, wherein said plurality of second testing feedback signals is corresponding to said plurality of second testing input signals; and
calculating said adaptive filter parameter from said plurality of first testing feedback signals, said plurality of first testing input signals, said plurality of second testing feedback signals, and said plurality of second testing input signals.

7. The operation method of the voice communication system with echo cancellation according to claim 2, further comprising a learning step, said learning step comprises following steps of:
placing said second transceiver device at a first testing position in a first testing space with no external sound interference;
transmitting a plurality of non-identical first testing input signals to said second sound generating portion respectively for generating an audio signal by said second sound generating portion;
capturing sound by said second sound capturing portion to output a plurality of first testing feedback signals respectively, wherein said plurality of first testing feedback signals is corresponding to said plurality of first testing input signals;
placing said second transceiver device at a second testing position in said first testing space with no external sound interference;
transmitting a plurality of non-identical second testing input signals to said second sound generating portion respectively for generating an audio signal by said second sound generating portion;
capturing sound by said second sound capturing portion to output a plurality of second testing feedback signals respectively, wherein said plurality of second testing feedback signals is corresponding to said plurality of second testing input signals;
placing said second transceiver device at a third testing position in a second testing space with no external sound interference;
transmitting a plurality of non-identical third testing input signals to said second sound generating portion respectively for generating an audio signal by said second sound generating portion;
capturing sound by said second sound capturing portion to output a plurality of third testing feedback signals respectively, wherein said plurality of third testing feedback signals is corresponding to said plurality of third testing input signals; and
calculating said adaptive filter parameter from said plurality of first testing feedback signals, said plurality of first testing input signals, said plurality of second testing feedback signals, said plurality of second testing input signals, said plurality of third testing feedback signals, and said plurality of third testing input signals.

8. The operation method of the voice communication system with echo cancellation according to claim 2, further comprising a learning step, said learning step comprises following steps of:
placing said second transceiver device at a first testing position in a first testing space with no external sound interference;
transmitting a plurality of non-identical first testing input signals to said second sound generating portion respectively for generating an audio signal by said second sound generating portion;
capturing sound by said second sound capturing portion to output a plurality of first testing feedback signals respectively, wherein said plurality of first testing feedback signals is corresponding to said plurality of first testing input signals;
placing said second transceiver device at a second testing position in said first testing space with no external sound interference;
transmitting a plurality of non-identical second testing input signals to said second sound generating portion respectively for generating an audio signal by said second sound generating portion;
capturing sound by said second sound capturing portion to output a plurality of second testing feedback signals respectively, wherein said plurality of second testing feedback signals is corresponding to said plurality of second testing input signals;
placing said second transceiver device at a third testing position in a second testing space with no external sound interference;
transmitting a plurality of non-identical third testing input signals to said second sound generating portion respectively for generating an audio signal by said second sound generating portion;
capturing sound by said second sound capturing portion to output a plurality of third testing feedback signals respectively, wherein said plurality of third testing feedback signals is corresponding to said plurality of third testing input signals;
placing said second transceiver device at a fourth testing position in said second testing space with no external sound interference;
transmitting a plurality of non-identical fourth testing input signals to said second sound generating portion respectively for generating an audio signal by said second sound generating portion;
capturing sound by said second sound capturing portion to output a plurality of fourth testing feedback signals respectively, wherein said plurality of fourth testing feedback signals is corresponding to said plurality of fourth testing input signals; and
calculating said adaptive filter parameter from said plurality of first testing feedback signals, said plurality of first testing input signals, said plurality of second testing feedback signals, said plurality of second testing input signals, said plurality of third testing feedback signals, said plurality of third testing input signals, said plurality of fourth testing feedback signals, and said plurality of fourth testing input signals.

9. The operation method of the voice communication system with echo cancellation according to claim 2, further comprising following steps of:
establishing a second connection between said first communication portion of said first transceiver device and a server; and
transmitting said adaptive filter parameter from said server to said first communication portion of said first transceiver device through said second connection and then to said audio signal processing portion, wherein said adaptive filter parameter is stored in said server.

10. A voice communication system with echo cancellation, comprising:
a first transceiver device, which comprises:
a first communication portion;
an audio signal processing portion;
a first sound generating portion; and
a first sound capturing portion for capturing sound to output a first residual echo signal to said audio signal processing portion, said audio signal processing portion cancels echo from said first residual echo signal to output a first echo-cancelled signal to said first communication portion;
a second transceiver device, which comprises:
a second communication portion, wherein a first connection is established between said first communication portion of said first transceiver device and said second communication portion of said second transceiver device;
a second sound generating portion, wherein said first echo-cancelled signal is transmitted from said first communication portion of said first transceiver device to said second communication portion of said second transceiver device through said first connection, and then to said second sound generating portion for generating an audio signal by said second sound generating portion; and
a second sound capturing portion for capturing sound to output a second residual echo signal to said second communication portion, wherein said second residual echo signal is transmitted from said second communication portion of said second transceiver device to said first communication portion of said first transceiver device through said first connection, and then to said audio signal processing portion, said audio signal processing portion cancels echo from said second residual echo signal to output a second echo-cancelled signal to said first sound generating portion for generating an audio signal by said first sound generating portion.

11. The voice communication system with echo cancellation according to claim 10, wherein said audio signal processing portion cancels echo from said second residual echo signal based on an adaptive filter parameter.

12. The voice communication system with echo cancellation according to claim 11, wherein when said second transceiver device is placed at a testing position in a testing space with no external sound interference, a plurality of non-identical testing input signals is transmitted to said second sound generating portion respectively for generating an audio signal by said second sound generating portion, said second sound capturing portion captures sound to output a plurality of testing feedback signals respectively, wherein said plurality of testing feedback signals is corresponding to said plurality of testing input signals, wherein said adaptive filter parameter is calculated from said plurality of testing input signals and said plurality of testing feedback signals.

13. The voice communication system with echo cancellation according to claim 11, wherein when said second transceiver device is placed at a first testing position in a testing space with no external sound interference, a plurality of non-identical first testing input signals is transmitted to said second sound generating portion respectively for generating an audio signal by said second sound generating portion, said second sound capturing portion captures sound to output a plurality of first testing feedback signals respectively, wherein said plurality of first testing feedback signals is corresponding to said plurality of first testing input signals; wherein when said second transceiver device is placed at a second testing position in said testing space with no external sound interference, a plurality of non-identical second testing input signals is transmitted to said second sound generating portion respectively for generating an audio signal by said second sound generating portion, said second sound capturing portion captures sound to output a plurality of second testing feedback signals respectively, wherein said plurality of second testing feedback signals is corresponding to said plurality of second testing input signals, wherein said adaptive filter parameter is calculated from said plurality of first testing feedback signals, said plurality of first testing input signals, said plurality of second testing feedback signals, and said plurality of second testing input signals.

14. The voice communication system with echo cancellation according to claim 11, wherein when said second transceiver device is placed at a first testing position in a first testing space with no external sound interference, a plurality of non-identical first testing input signals is transmitted to said second sound generating portion respectively for generating an audio signal by said second sound generating portion, said second sound capturing portion captures sound to output a plurality of first testing feedback signals respectively, wherein said plurality of first testing feedback signals is corresponding to said plurality of first testing input signals; wherein when said second transceiver device is placed at a second testing position in a second testing space with no external sound interference, a plurality of non-identical second testing input signals is transmitted to said second sound generating portion respectively for generating an audio signal by said second sound generating portion, said second sound capturing portion captures sound to output a plurality of second testing feedback signals respectively, wherein said plurality of second testing feedback signals is corresponding to said plurality of second testing input signals, wherein said adaptive filter parameter is calculated from said plurality of first testing feedback signals, said plurality of first testing input signals, said plurality of second testing feedback signals, and said plurality of second testing input signals.

15. The voice communication system with echo cancellation according to claim 11, wherein when said second transceiver device is placed at a first testing position in a first testing space with no external sound interference, a plurality of non-identical first testing input signals is transmitted to said second sound generating portion respectively for generating an audio signal by said second sound generating portion, said second sound capturing portion captures sound to output a plurality of first testing feedback signals respectively, wherein said plurality of first testing feedback signals is corresponding to said plurality of first testing input signals; wherein when said second transceiver device is placed at a second testing position in said first testing space with no external sound interference, a plurality of non-identical second testing input signals is transmitted to said second sound generating portion respectively for generating an audio signal by said second sound generating portion, said second sound capturing portion captures sound to output a plurality of second testing feedback signals respectively, wherein said plurality of second testing feedback signals is corresponding to said plurality of second testing input signals; wherein when said second transceiver device is placed at a third testing position in a second testing space with no external sound interference, a plurality of non-identical third testing input signals is transmitted to said second sound generating portion respectively for generating an audio signal by said second sound generating portion, said second sound capturing portion captures sound to output a plurality of third testing feedback signals respectively, wherein said plurality of third testing feedback signals is corresponding to said plurality of third testing input signals, wherein said adaptive filter parameter is calculated from said plurality of first testing feedback signals, said plurality of first testing input signals, said plurality of second testing feedback signals, said plurality of second testing input signals, said plurality of third testing feedback signals, and said plurality of third testing input signals.

16. The voice communication system with echo cancellation according to claim 11, wherein when said second transceiver device is placed at a first testing position in a first testing space with no external sound interference, a plurality of non-identical first testing input signals is transmitted to said second sound generating portion respectively for generating an audio signal by said second sound generating portion, said second sound capturing portion captures sound to output a plurality of first testing feedback signals respectively, wherein said plurality of first testing feedback signals is corresponding to said plurality of first testing input signals; wherein when said second transceiver device is placed at a second testing position in said first testing space with no external sound interference, a plurality of non-identical second testing input signals is transmitted to said second sound generating portion respectively for generating an audio signal by said second sound generating portion, said second sound capturing portion captures sound to output a plurality of second testing feedback signals respectively, wherein said plurality of second testing feedback signals is corresponding to said plurality of second testing input signals; wherein when said second transceiver device is placed at a third testing position in a second testing space with no external sound interference, a plurality of non-identical third testing input signals is transmitted to said second sound generating portion respectively for generating an audio signal by said second sound generating portion, said second sound capturing portion captures sound to output a plurality of third testing feedback signals respectively, wherein said plurality of third testing feedback signals is corresponding to said plurality of third testing input signals; wherein when said second transceiver device is placed at a fourth testing position in said second testing space with no external sound interference, a plurality of non-identical fourth testing input signals is transmitted to said second sound generating portion respectively for generating an audio signal by said second sound generating portion, said second sound capturing portion captures sound to output a plurality of fourth testing feedback signals respectively, wherein said plurality of fourth testing feedback signals is corresponding to said plurality of fourth testing input signals, wherein said adaptive filter parameter is calculated from said plurality of first testing feedback signals, said plurality of first testing input signals, said plurality of second testing feedback signals, said plurality of second testing input signals, said plurality of third testing feedback signals, said plurality of third testing input signals, said plurality of fourth testing feedback signals, and said plurality of fourth testing input signals.

17. The voice communication system with echo cancellation according to claim 11, wherein said adaptive filter parameter is stored in a server, said adaptive filter parameter is transmitted from said server to said first communication portion of said first transceiver device through a second connection established between said first communication portion of said first transceiver device and said server, and then to said audio signal processing portion.

18. A transceiver device with echo cancellation, comprising:
a first communication portion;
an audio signal processing portion;
a first sound generating portion; and
a first sound capturing portion for capturing sound to output a first residual echo signal to said audio signal processing portion; wherein said audio signal processing portion cancels echo from said first residual echo signal to output a first echo-cancelled signal to said first communication portion; wherein said first echo-cancelled signal is transmitted from said first communication portion of said transceiver device to a second communication portion of a second transceiver device through a first connection established between said first communication portion and said second communication portion, and then to a second sound generating portion of said second transceiver device for generating an audio signal by said second sound generating portion; wherein said second communication portion of said second transceiver device transmits a second residual echo signal outputted by a second sound capturing portion of said second transceiver device to said first communication portion of said transceiver device through said first connection, and then to said audio signal processing portion; wherein said audio signal processing portion cancels echo from said second residual echo signal to output a second echo-cancelled signal to said first sound generating portion for generating an audio signal by said first sound generating portion.

19. The transceiver device with echo cancellation according to claim 18, wherein said audio signal processing portion cancels echo from said second residual echo signal based on an adaptive filter parameter.

20. The transceiver device with echo cancellation according to claim 19, wherein said adaptive filter parameter is stored in a server, said adaptive filter parameter is transmitted from said server to said first communication portion of said transceiver device through a second connection established between said first communication portion of said transceiver device and said server, and then to said audio signal processing portion.
